(19) United States
(12) Patent Application Publication
(10) Pub. No.: US 2009/0198062 A1
(43) Pub. Date: Aug. 6, 2009

(54) NOVEL PROCESS

(76) Inventors: Vinayak G. Gore, Panvel (IN); Vinay Kumar Shukla, Panvel (IN); Manoj M. Ghadge, Panvel (IN); Rekha M. Avadhut, Panvel (IN)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 12/341,235

(22) Filed: Dec. 22, 2008

Related U.S. Application Data
(63) Continuation of application No. PCT/GB2007/050374, filed on Jul. 3, 2007.

(30) Foreign Application Priority Data
Jul. 3, 2006 (IN) 1051/MUM/2006

(51) Int. Cl. C07F 9/48

(52) U.S. Cl. 546/22

(57) ABSTRACT

The present invention relates to a process for the preparation of bisphosphonic acids and salts thereof, in particular monosodium salts thereof. The invention also relates to the conversion of the bisphosphonic acids to their sodium salts using an aqueous-organic solvent system. The present invention further relates to the conversion of variable hydrate forms of risedronic acid monosodium salt into a pharmaceutically acceptable hemipentahydrate form by crystallization using an aqueous-organic solvent system.

### CROSS REFERENCE TO RELATED APPLICATIONS

This application is a continuation of International Patent Application No. PCT/GB2007/050374, filed on Jul. 3, 2007, which claims priority to India Patent Application No. 1051/mum/2006, filed on Jul. 3, 2006, the entire contents of both of which are incorporated herein by reference.

### FIELD OF THE INVENTION

The present invention relates to a process for the preparation of bisphosphonic acids and salts thereof, in particular monosodium salts thereof. The invention also relates to the conversion of the bisphosphonic acids to their sodium salts using an aqueous-organic solvent system. The present invention further relates to the conversion of variable hydrate forms of risedronic acid monosodium salt into a pharmaceutically acceptable hemipentahydrate form by crystallization using an aqueous-organic solvent system.

### BACKGROUND OF THE INVENTION

Bisphosphonic acids are used for the treatment of bone disorders such as Paget's disease and osteoporosis. Bisphosphonic acids inhibit abnormal calcium and phosphate metabolism that causes resorption of bone tissue and hence bisphosphonic acids are useful for the treatment of diseases associated with excessive bone loss.

In the prior art, bisphosphonic acids were prepared and used as agrochemicals. U.S. Pat. No. 5,583,122 by Proctor and Gamble discloses the use of bisphosphonic acids as a drug for the treatment of bone disorders.

Bisphosphonic acids are generally prepared by phosphorylation of a carboxylic acid with a phosphorous halide and/or phosphorous acid. The reaction mixture comprising a phosphorous intermediate is hydrolyzed with water to obtain a free bisphosphonic acid, which can then be converted into the monosodium salt by treating with sodium hydroxide solution. In bisphosphonic acids RCH₂—CO₂H, the RCH₂— group may be, for example, as shown in Table 1.

TABLE 1

| RCH₂— group | Bisphosphonic acid |
|---|---|
| H—(CH₂)— | etidronic acid |
| H₂N—(CH₂)₂— | pamidronic acid |
| H₂N—(CH₂)₃— | alendronic acid |
| H₂N—(CH₂)₅— | neridronic acid |
| 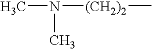 | olpadronic acid |
| 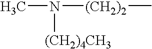 | ibandronic acid |
| 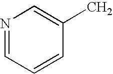 | risedronic acid |
| 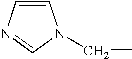 | zoledronic acid |
| 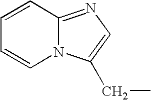 | minodronic acid |

The chemical reaction for the preparation of bisphosphonic acid monosodium salts can be as shown in Scheme 1.

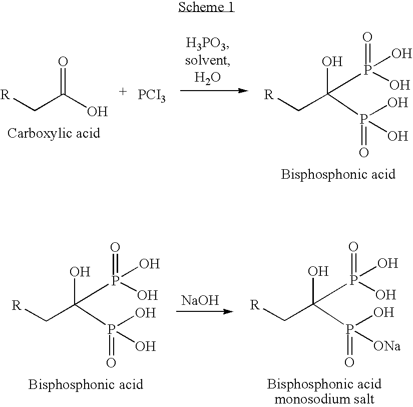

It has been found that the phosphorous intermediate, formed during the phosphorylation reaction of the carbonyl group of the carboxylic acid, is highly viscous. The high viscosity causes the stirring device to jam, impedes smooth mixing of the reaction mass, causes problems with reaction mass uniformity and leads to an incomplete reaction. Various solvents or carriers used for the phosphorylation reaction, to render the reaction mass stirrable, are reported in the literature. However, all of these solvents have certain limitations.

It is difficult to establish a relationship between the physicochemical nature of a solvent and its use in the phosphorylation reaction. The solvents used in the prior art are basic, neutral or acidic. Similarly, they are ionic or non-ionic, and polar or non-polar. The solvents used include common solvents like toluene and chlorobenzene, and specialty solvents like morpholine, piperidine, long chain glycols, sulfolane, aralkyl and alkyl ethoxylates and reagents like methane sulfonic acid and phase transfer catalysts (ionic liquids).

U.S. Pat. No. 5,583,122 and U.S. Pat. No. 4,407,761 disclose the use of chlorinated hydrocarbons, especially chlorobenzene, as diluent in the phosphorylation reaction. In fact, it was found that chlorobenzene acts only as a heat carrier, but does not solubilise the reactants and the reaction mass exists as a biphasic system. The problem of stirring due to gradual thickening of the reaction mass still persists, which results in the deposition of reaction mass on the wall of the reaction vessel. This results in incomplete reaction and leads to problems with the reaction work-up. Further, chlorobenzene is an aromatic halogenated hydrocarbon, which is harmful to the user and the environment when used on a large scale. These problems make it difficult to scale-up the process to commercial quantities.

U.S. Pat. No. 4,705,651 advocates carrying out the phosphorylation reaction in the absence of any solvents, using particular molar ratios in an attempt to keep the reaction mixture fluid. Again, however, the process suffers from a hardening of the reaction mass during the phosphorylation reaction and consequent stirring problems and incomplete mixing and therefore poor product yield and quality.

U.S. Pat. No. 4,922,007 and U.S. Pat. No. 5,019,651 disclose the use of methane sulfonic acid as solvent for the phosphorylation reaction. The reaction mass turns homogenous as the reaction components solubilise. In spite of this positive property of methane sulfonic acid, its use has a major restriction on temperature. It was reported that if the reaction temperature exceeds 70° C., an exothermic reaction between methane sulfonic acid and phosphorous trichloride starts and the reaction temperature suddenly exceeds beyond control, which is highly hazardous. Moreover, methane sulfonic acid is a corrosive solvent and recycling it is tedious.

U.S. Pat. No. 5,908,959 discloses the use of various long chain glycols as solvent in the phosphorylation reaction. The problem of solidification of the reaction mass was found to be only partially controlled. Moreover, formation of toxic chloro derivatives of these solvents during the course of the phosphorylation reaction prevents recycling of these solvents.

In WO 00/49026, the problem of stirring the reaction mass was avoided by starting the reaction with nitrogen protected amino carboxylic acids and using ortho-phosphoric acid as diluent in the reaction. Introduction of additional protection (with N-phthalimido or N-maleimido) and deprotection steps to obtain the final products restricts the wide application of this process.

USSN 2001/0041690 describes the use of various bases like morpholine or pyridine or their hydrochloride salts as solvent to overcome the stirring problem. The higher cost of these bases and recovery problems restrict the commercial utilization of these bases as solvent of choice.

WO 02/090367 describes the use of aralkyl or alkyl ethoxylates or triglycerides such as plant or animal oils or their derivatives as solvent for the reaction and preparation of bisphosphonic acid salts of 4-aminobutyric acid. The separation of solvent oil from the reaction mass after completion of the reaction and the isolation of the product is inconvenient. At the same time, recycling of the solvent is not possible, which restricts the commercial viability of the process.

WO 03/093282 discloses the synthesis of various bisphosphonic acids using various ionic liquids as solvent for the phosphorylation reaction. Various ionic solvents such as onium salts derived from ammonium, sulfonium or phosphonium ions were used. The problem of stirring the reaction mass was reduced to a certain extent, but removal of the solvent after completion of the reaction and its recycling is cumbersome. Hence, the use of ionic liquids is not beneficial, as it makes the process expensive without improving its workability.

USSN 2004/0043967 discloses use of an aromatic hydrocarbon or a silicone fluid as diluent. When an aromatic hydrocarbon like toluene is used as diluent, ortho-phosphoric acid or a heterogeneous solid support may also be used. The separation of the solvent after completion of the reaction can only be achieved incompletely and the higher cost of the solvent again restricts the commercial viability of this process.

WO 2005/044831 discloses the preparation of bisphosphonic acids and their salts in a water miscible neutral solvent, sulfolane. The solvent can be removed after completion of the reaction and it is claimed that it allows smooth stirring of the reaction mass. However, sulfolane is an expensive solvent and due to its solubility in water, it is difficult to recover after completion of the reaction. Besides, the toxic nature of this solvent also restricts its use on a commercial scale.

It is thus observed that the common limitations in the process of making bisphosphonic acids and their monosodium salts are:
1. Improper agitation on account of sudden formation of phosphorous intermediates in hard lumpy solid form.
2. Use of a complex system of diluents and co-diluents to overcome this problem. Some of the prior art methods used water immiscible aromatic hydrocarbons like chlorobenzene, toluene or silicone oils etc, while others used water miscible soluble solvents like long chain glycols, morpholine or sulfolane etc, which are expensive.

### OBJECT OF THE INVENTION

It is an object of the present invention to overcome or ameliorate at least one of the disadvantages of the prior art and to provide an economical and commercially scalable synthetic process for manufacturing bisphosphonic acids and their monosodium salts.

It is also an object of the present invention to provide for an economical, environmentally safe process using user-friendly, recyclable solvents for the preparation of bisphosphonic acids and their monosodium salts.

It is a further object of the present invention to provide the bisphosphonic acids and their monosodium salts in good yield.

### SUMMARY OF THE INVENTION

A first aspect of the present invention provides a process of preparing a bisphosphonic acid or a salt thereof, comprising the step of phosphorylating a carboxylic acid or a salt thereof with phosphorous acid and a phosphorous halide in the presence of a polar organic solvent, provided that the polar organic solvent is not methane sulfonic acid, sulfolane, 1,2-dimethoxyethane, dioxane or diglyme. If a bisphosphonic acid salt is prepared, this may be a sodium, potassium, calcium or magnesium salt, preferably a sodium salt such as a mono-, di-, tri- or tetrasodium salt, preferably a mono- or disodium salt, preferably a monosodium salt.

A preferred carboxylic acid or a salt thereof is RCH₂—CO₂H or a salt thereof, wherein R is an alkyl, aralkyl, aromatic or heteroaromatic group which can be optionally substituted with —NR₁R₂ where R₁ and R₂ are independently hydrogen or an alkyl group. A preferred —NR₁R₂, group is —NH₂. Preferably, the carboxylic acid is selected from acetic acid, 3-amino-propionic acid, 4-amino-butyric acid, 6-amino-hexanoic acid, 3-(dimethylamino)-propionic acid, N-(n-pentyl)-N-methyl-3-amino-propionic acid, 3-pyridyl-acetic acid, 1-imidazolyl-acetic acid, or (3-imidazo[1,2-a]pyridine)-acetic acid.

For the purposes of the present invention, an “alkyl” group is defined as a monovalent saturated hydrocarbon, which may be straight-chain or branched-chain, or be or include cyclic groups. Examples of alkyl groups are methyl, ethyl, n-propyl, i-propyl, n-butyl, i-butyl, t-butyl and n-pentyl groups. Preferred alkyl groups are C₁₋₆ straight-chain, C₁₋₆ branched-chain, cyclic and lower alkyl groups. Preferably, a lower alkyl group comprises from 1 to 6 carbon atoms, preferably from 1 to 4. Preferably, a cyclic alkyl group comprises from 4 to 8 carbon atoms, preferably 5 or 6.

An “aromatic” group is defined as a monovalent aromatic hydrocarbon. Examples of aromatic groups are phenyl, naphthyl, anthracenyl and phenanthrenyl groups. Preferably, an aromatic group comprises from 4 to 14 carbon atoms, preferably from 6 to 10.

A “heteroaromatic” group is an aromatic group which includes one or more heteroatoms in its aromatic carbon skeleton. Preferred heteroatoms are N, O and S, preferably N. Examples of heteroaromatic groups are pyridyl, imidazolyl and imidazo[1,2-a]pyridyl groups.

An “aralkyl” group comprises an aromatic and an alkyl moiety, with the alkyl moiety being attached to the rest of the molecule. An example of an aralkyl group is benzyl. Preferably, an aralkyl group comprises from 4 to 14 carbon atoms, preferably from 6 to 10.

Any carboxylic acid salt may be phosphorylated by the process of the first aspect of the present invention. A preferred salt is a hydrochloride salt.

Preferably, the phosphorous halide is selected from phosphorous trichloride, phosphorous pentachloride or phosphorous oxychloride.

Preferably, the process further comprises the step of preparing a salt of the bisphosphonic acid. Preferably, the salt is a sodium, potassium, calcium or magnesium salt, preferably a sodium salt such as a mono-, di-, tri- or tetrasodium salt, preferably a mono- or disodium salt, preferably a monosodium salt.

Preferably, the bisphosphonic acid salt is prepared in the presence of water and a polar organic solvent.

Preferably, the process further comprises the step of recrystallising the bisphosphonic acid salt using water and a polar organic solvent.

Preferably, the solvent used in any of the steps of the process of the first aspect of the present invention is selected from an organonitrile, a ketone, a cyclic ether, or a mixture thereof. Preferably, the solvent is selected from acetonitrile, benzonitrile, propionitrile, acetone, tetrahydrofuran, N-methyl-pyrrolidinone, dimethylformamide, dimethylacetamide, dimethyl sulfoxide, or a mixture thereof. Preferably, the solvent is selected from acetonitrile, benzonitrile, propionitrile, acetone, tetrahydrofuran, N-methyl-pyrrolidinone, or a mixture thereof. N-methyl-pyrrolidinone is also called 1-methyl-2-pyrrolidinone. A solvent mixture may be an equal volume mixture of two of these solvents. Preferably, the solvent is not a chlorinated hydrocarbon, a poly(alkylene) glycol or a derivative thereof, ortho-phosphoric acid, a nitrogen base, a carbonate, a bicarbonate, an aralkyl or alkyl ethoxylate, a triglyceride, an ionic solvent, a silicone fluid, a glyme, or an ether. Preferably, the solvent is not phosphorous acid, meaning that phosphorous acid is used as a reagent not as a solvent, preferably in amounts of up to 5 equivalents with respect to the carboxylic acid, preferably up to 4 equivalents, 3 equivalents, or 2 equivalents.

Preferably, the solvent used for the phosphorylation step and the solvent used for the salt preparation step are the same. Preferably, the solvent used for the phosphorylation step and the solvent used for the recrystallisation step are the same. Preferably, the solvent used for the salt preparation step and the solvent used for the recrystallisation step are the same.

Preferably, the solvent used for the phosphorylation step, the solvent used for the salt preparation step and the solvent used for the recrystallisation step are the same. Preferably, the process of the first aspect of the present invention is a single-pot reaction process. The single-pot reaction process comprises the phosphorylation reaction and the hydrolysis of the phosphorous intermediate formed. It may also comprise the preparation of a bisphosphonic acid salt. It may also comprise the recrystallisation of the bisphosphonic acid salt.

Preferably, the bisphosphonic acid or the salt thereof is obtained on an industrial scale, preferably in batches of 50 g, 100 g, 500 g, 1 kg, 5 kg, 10 kg, 50 kg, 100 kg or more.

Preferably, the bisphosphonic acid or the salt thereof is obtained in a yield of more than 40%, preferably more than 50%, more than 60%, more than 70%, more than 75%, or more than 80%.

Preferably, the bisphosphonic acid or the salt thereof is obtained with an HPLC purity of more than 97%, preferably more than 98%, more than 99%, more than 99.5%, or more than 99.7%.

A second aspect of the present invention provides a process of preparing a bisphosphonic acid salt, comprising the step of converting a bisphosphonic acid into a salt thereof in the presence of water and a polar organic solvent, provided that the polar organic solvent is not methane sulfonic acid, sulfolane, 1,2-dimethoxyethane, dioxane or diglyme.

A third aspect of the present invention provides a process of recrystallising a bisphosphonic acid salt using water and a polar organic solvent. Preferably, the polar organic solvent is not methane sulfonic acid, sulfolane, 1,2-dimethoxyethane, dioxane or diglyme.

The preferred embodiments of the first aspect of the present invention also apply to the second and third aspects of the present invention, wherever possible.

A fourth aspect of the present invention provides a bisphosphonic acid or a salt thereof, when prepared by a process of the first, second or third aspect of the present invention. Preferably, the bisphosphonic acid has an HPLC purity of more than 97%, preferably more than 98%, more than 99%, more than 99.5%, or more than 99.7%.

A fifth aspect of the present invention provides a process of preparing sodium risedronate hemipentahydrate, comprising the steps of:
(a) phosphorylating 3-pyridyl-acetic acid with phosphorous acid and a phosphorous halide in the presence of a polar organic solvent selected from acetonitrile, benzonitrile, propionitrile, acetone, tetrahydrofuran, N-methyl-pyrrolidinone, dimethylformamide, dimethylacetamide, dimethyl sulfoxide, or a mixture thereof, to obtain a phosphorous intermediate;
(b) hydrolysing the phosphorous intermediate with sodium hydroxide to obtain sodium risedronate;
(c) recrystallising the sodium risedronate using water and the same polar organic solvent used in step (a) to obtain sodium risedronate hemipentahydrate.

Preferably, the phosphorous halide is selected from phosphorous trichloride, phosphorous pentachloride or phosphorous oxychloride.

Preferably, the solvent is selected from acetonitrile, benzonitrile, propionitrile, acetone, tetrahydrofuran, N-methyl-pyrrolidinone, or a mixture thereof. Preferably, the solvent is selected from acetonitrile, acetone, tetrahydrofuran or N-methyl-pyrrolidinone. N-methyl-pyrrolidinone is also called 1-methyl-2-pyrrolidinone. A solvent mixture may be an equal volume mixture of two of these solvents.

Preferably, the process of the fifth aspect of the present invention is a single-pot reaction process. The single-pot reaction process comprises the phosphorylation reaction, the hydrolysis of the phosphorous intermediate formed, the preparation of sodium risedronate, and the recrystallisation of sodium risedronate in hemipentahydrate form.

Preferably, the sodium risedronate hemipentahydrate is obtained on an industrial scale, preferably in batches of 50 g, 100 g, 500 g, 1 kg, 5 kg, 10 kg, 50 kg, 100 kg or more.

Preferably, the sodium risedronate hemipentahydrate is obtained in a yield of more than 40%, preferably more than 45%, more than 50%, or more than 55%.

Preferably, the sodium risedronate hemipentahydrate is obtained with an HPLC purity of more than 98%, preferably more than 99%, more than 99.5%, or more than 99.7%.

Preferably, the sodium risedronate hemipentahydrate is obtained substantially free from other hydrates. Substantially free from other hydrates means that the sodium risedronate hemipentahydrate comprises less than 2% of other hydrates including anhydrates, preferably less than 1%, less than 0.5%, less than 0.2%, or less than 0.1%.

A sixth aspect of the present invention provides a process of recrystallising risedronate sodium in hemipentahydrate form using water and a polar organic solvent. Preferably, sodium risedronate hemipentahydrate is prepared from sodium risedronate in one or more other hydrate or anhydrate forms.

Four hydration states are known for risedronate monosodium, namely an anhydrate, a monohydrate, a hemipentahydrate and a variable hydrate. The anhydrate, monohydrate, variable hydrate or a mixture thereof may be recrystallised in hemipentahydrate form in accordance with the sixth aspect of the present invention. Preferably, sodium risedronate in variable hydrate form is recrystallised in hemipentahydrate form.

Preferably, the solvent is selected from an organonitrile, a ketone, a cyclic ether, or a mixture thereof. Preferably, the solvent is selected from acetonitrile, benzonitrile, propionitrile, acetone, tetrahydrofuran, N-methyl-pyrrolidinone, dimethylformamide, dimethylacetamide, dimethyl sulfoxide, or a mixture thereof. Preferably, the solvent is selected from acetonitrile, benzonitrile, propionitrile, acetone, tetrahydrofuran, N-methyl-pyrrolidinone, or a mixture thereof. N-methyl-pyrrolidinone is also called 1-methyl-2-pyrrolidinone. A solvent mixture may be an equal volume mixture of two of these solvents. Preferably, the polar organic solvent is not methane sulfonic acid, sulfolane, 1,2-dimethoxyethane, dioxane or diglyme. Preferably, the solvent is not a chlorinated hydrocarbon, a poly(alkylene) glycol or a derivative thereof, ortho-phosphoric acid, phosphorous acid, a nitrogen base, a carbonate, a bicarbonate, an aralkyl or alkyl ethoxylate, a triglyceride, an ionic solvent, a silicone fluid, a glyme, or an ether.

Preferably, the sodium risedronate hemipentahydrate is obtained on an industrial scale, preferably in batches of 50 g, 100 g, 500 g, 1 kg, 5 kg, 10 kg, 50 kg, 100 kg or more.

Preferably, the sodium risedronate hemipentahydrate is obtained in a yield of more than 40%, preferably more than 50%, more than 60%, more than 70%, more than 75%, or more than 80%.

Preferably, the sodium risedronate hemipentahydrate is obtained with an HPLC purity of more than 98%, preferably more than 99%, more than 99.5%, or more than 99.7%.

Preferably, the sodium risedronate hemipentahydrate is obtained substantially free from other hydrates. Substantially free from other hydrates means that the sodium risedronate hemipentahydrate comprises less than 2% of other hydrates including anhydrates, preferably less than 1%, less than 0.5%, less than 0.2%, or less than 0.1%.

A seventh aspect of the present invention provides sodium risedronate hemipentahydrate, when prepared by a process of the fifth or sixth aspect of the present invention.

An eighth aspect of the present invention provides sodium risedronate hemipentahydrate with an HPLC purity of more than 99.5%, preferably more than 99.7%.

A ninth aspect of the present invention provides an industrial process of preparing sodium risedronate hemipentahydrate, wherein the sodium risedronate hemipentahydrate has an HPLC purity of more than 99.5%, preferably more than 99.7%, and is substantially free from other hydrates. Here, substantially free from other hydrates means that the sodium risedronate hemipentahydrate comprises less than 0.5% of other hydrates including anhydrates, preferably less than 0.2%, or less than 0.1%. Preferably, sodium risedronate hemipentahydrate is prepared from sodium risedronate in one or more other hydrate or anhydrate forms.

Four hydration states are known for risedronate monosodium, namely an anhydrate, a monohydrate, a hemipentahydrate and a variable hydrate. Sodium risedronate hemipentahydrate may be prepared from the anhydrate, monohydrate, variable hydrate or a mixture thereof in accordance with the ninth aspect of the present invention. Preferably, sodium risedronate hemipentahydrate is prepared from sodium risedronate in variable hydrate form.

An industrial process means that the sodium risedronate hemipentahydrate is obtained on an industrial scale, preferably in batches of 50 g, 100 g, 500 g, 1 kg, 5 kg, 10 kg, 50 kg, 100 kg or more.

In a preferred embodiment, the sodium risedronate according to the fifth to ninth aspects of the present invention is risedronate monosodium.

A tenth aspect of the present invention provides an industrial process of preparing sodium risedronate, comprising the step of phosphorylating 3-pyridyl-acetic acid in the presence of a polar, water miscible, organic solvent.

Preferably, the solvent reduces, prevents or ameliorates the hardening of the reaction mass during the phosphorylation reaction. Preferably, the solvent is selected from an organonitrile, a ketone, a cyclic ether, or a mixture thereof. Preferably, the solvent is selected from acetonitrile, benzonitrile, propionitrile, acetone, tetrahydrofuran, N-methyl-pyrrolidinone, dimethylformamide, dimethylacetamide, dimethyl sulfoxide, or a mixture thereof. Preferably, the solvent is selected from acetonitrile, benzonitrile, propionitrile, acetone, tetrahydrofuran, N-methyl-pyrrolidinone, or a mixture thereof. N-methyl-pyrrolidinone is also called 1-methyl-2-pyrrolidinone. A solvent mixture may be an equal volume mixture of two of these solvents. Preferably, the polar organic solvent is not methane sulfonic acid, sulfolane, 1,2-dimethoxyethane, dioxane or diglyme. Preferably, the solvent is not a chlorinated hydrocarbon, a poly(alkylene) glycol or a derivative thereof, ortho-phosphoric acid, a nitrogen base, a carbonate, a bicarbonate, an aralkyl or alkyl ethoxylate, a triglyceride, an ionic solvent, a silicone fluid, a glyme, or an ether. Preferably, the solvent is not phosphorous acid, meaning that phosphorous acid may be used as a reagent but not as a solvent, preferably in amounts of up to 5 equivalents with respect to the carboxylic acid, preferably up to 4 equivalents, 3 equivalents, or 2 equivalents.

An industrial process means that the sodium risedronate is obtained on an industrial scale, preferably in batches of 50 g, 100 g, 500 g, 1 kg, 5 kg, 10 kg, 50 kg, 100 kg or more.

In all aspects of the present invention, a polar organic solvent is used. Generally, solvents with a large dipole moment and a high dielectric constant are considered polar. Preferably, the polar organic solvent used in the present invention has a dipole moment of 1.7 Debye or more, preferably 2.0 Debye or more, preferably 2.5 Debye or more, and/or preferably 4.3 Debye or less, preferably 4.2 Debye or less. Preferably, the polar organic solvent used in the present invention has a dielectric constant of 7 or more, preferably 10 or more, preferably 15 or more, preferably 20 or more, and/or preferably 42 or less. In one embodiment of the present invention, the polar organic solvent is aprotic. In another embodiment of the present invention, the polar organic solvent has a boiling point of less than 250° C. In yet another embodiment of the present invention, the polar organic solvent is not miscible with water in all ratios.

Preferably, the polar organic solvent used in the present invention is selected from an organonitrile, a ketone, a cyclic ether, an amide, a sulfoxide, a phosphoramide, or a mixture thereof. Preferably, the solvent is selected from an organonitrile, a ketone, an amide, a sulfoxide, a phosphoramide, or a mixture thereof. Preferably, the solvent is selected from an organonitrile, a ketone, an amide, a phosphoramide, or a mixture thereof. Preferably, the solvent is selected from an organonitrile, a ketone, a cyclic ether, or a mixture thereof.

Preferred organonitriles are acetonitrile, benzonitrile, propionitrile, n-butyronitrile, and i-butyronitrile. Preferred ketones are acetone, N-methyl-pyrrolidinone, and butanone. N-methyl-pyrrolidinone is also called 1-methyl-2-pyrrolidinone. A preferred cyclic ether is tetrahydrofuran. Preferred amides are dimethylformamide and dimethylacetamide. A preferred sulfoxide is dimethyl sulfoxide. A preferred phosphoramide is hexamethyl phosphoramide.

### DETAILED DESCRIPTION OF THE INVENTION

The present invention provides a process of phosphorylating a carboxylic acid RCH₂—CO₂H, wherein R is an alkyl, aralkyl, aromatic or heteroaromatic group which can be optionally substituted with —NR₁R₂ where R₁ and R₂ may be selected from hydrogen or a C₁₋₆ straight-chain, C₁₋₆ branched-chain, cyclic or lower alkyl group, or a salt thereof such as a hydrochloride salt, with phosphorous acid and a phosphorous halide, particularly phosphorous trichloride, phosphorous pentachloride or phosphorous oxychloride, in the presence of an organic solvent, particularly organonitriles such as acetonitrile, ketones such as acetone or N-methyl-pyrrolidinone, cyclic ethers such as tetrahydrofuran, or mixtures thereof such as equal volume mixtures.

RCH₂—CO₂H is defined as acetic acid in the case of etidronic acid, 3-amino-propionic acid in the case of pamidronic acid, 4-amino-butyric acid in the case of alendronic acid, 6-amino-hexanoic acid in the case of neridronic acid, 3-(dimethylamino)-propionic acid in the case of olpadronic acid, N-(n-pentyl)-N-methyl-3-amino-propionic acid in the case of ibandronic acid, 3-pyridyl-acetic acid in the case of risedronic acid, 1-imidazolyl-acetic acid in the case of zoledronic acid, and (3-imidazo[1,2-a]pyridine)-acetic acid in the case of minodronic acid.

Polar organic solvents were selected based on the nature of the reaction and the reactivity of the solvent.

The inventors found that polar solvents used for the phosphorylation reaction helped the reaction as it involves polar intermediates.

Similarly, the inventors found that the criterion of water miscibility was important for the selection of the solvent for the hydrolysis to liberate the bisphosphonic acid. Solvents such as acetonitrile, tetrahydrofuran and N-methyl-pyrrolidinone employed in the present invention gave the best results. Apart from this, acetonitrile and tetrahydrofuran can be easily recovered (distilled). All of these solvents are commercially available and cheap.

The problem of hardening of the reaction mass and improper mixing was overcome and the reaction went to completion smoothly. Since solvents such as acetonitrile, acetone, N-methyl-pyrrolidinone and tetrahydrofuran are soluble in water, the reaction mixture can be taken directly into water for hydrolysis without removal of the solvent. Alternatively, the solvent can be distilled before hydrolysis and recycled back. Moreover, the final product, bisphosphonic acid monosodium salt, can be isolated directly after pH adjustment of the reaction mixture in a one-pot reaction.

The process of the present invention involves the preparation of a bisphosphonic acid, for example risedronic acid or its monosodium salt, by reacting a carboxylic acid, for example 3-pyridyl-acetic acid or its hydrochloride salt, with phosphorous acid and a phosphorous halide, like phosphorous trichloride, phosphorous pentachloride or phosphorous oxychloride, in the presence of a water miscible solvent like acetonitrile, acetone, N-methyl-pyrrolidinone, tetrahydrofuran, or a mixture thereof such as an equal volume mixture of any two of these solvents.

Risedronic acid monosodium salt so prepared was found sufficiently pure (˜98% HPLC) and it can be further purified to >99.5% (HPLC) by using a mixture of water:acetonitrile, water:acetone or water:tetrahydrofuran as a solvent system for crystallization to obtain a hydrated polymorph such as a monohydrate or a hemipentahydrate form. The hemipentahydrate form is a preferred form used in pharmaceutical formulations. The use of the same solvent for the synthesis as well as the purification/crystallization helped to avoid complications in having to detect various solvents in organic volatile impurity (OVI) tests required for final active pharmaceutical ingredient (API) analysis.

The crude risedronic monosodium salt was found to be a variable hydrate based on the comparison of XRPD data (J. Pharm. Sci., 2005, vol. 94, no. 4, pages 893-911). Unlike the reported processes for the preparation of the hemipentahydrate form, the hemipentahydrate was prepared by dissolving crude risedronic monosodium salt (in the variable hydrate form) in water at 60-65° C. followed by addition of either acetonitrile, acetone or tetrahydrofuran for initiation of the crystallization. The solution was then cooled to obtain crystalline risedronic acid monosodium salt in hemipentahydrate form with >99.5% HPLC purity, see Scheme 2.

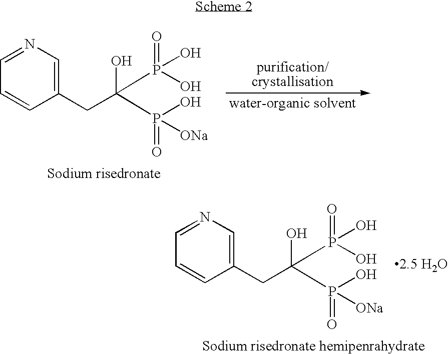

The present invention describes the use of safe, water miscible, neutral and inexpensive solvents for the preparation of bisphosphonic acids and their monosodium salts, for example acetonitrile, tetrahydrofuran or acetone. The solvent used in the reaction can be easily recovered from the reaction mass or mother liquor after the end of the reaction. Hence, the process is ecofriendly and does not cause any problems with effluent treatment.

In a preferred embodiment of the present invention, the process is a single-pot reaction process comprising all three reactions, i.e. the phosphorylation reaction, the hydrolysis of the phosphorous intermediate so formed and finally the preparation of the bisphosphonic acid monosodium salt. The single-pot reaction process helps further in enhancing the yield of the final product (56-66%).

The process of the present invention is used for the preparation of bisphosphonic acids like risedronic acid, pamidronic acid, alendronic acid, zoledronic acid, ibandronic acid, minodronic acid, neridronic acid, olpadronic acid etc, starting from the corresponding carboxylic acid or a salt thereof such as a hydrochloride salt.

In a preferred embodiment of the present invention, the phosphorylation reaction was carried out by slow addition of phosphorous trichloride to a mixture of a carboxylic acid (for example, 3-pyridyl-acetic acid or its hydrochloride, 3-amino-propionic acid, 4-amino-butyric acid or 6-amino-hexanoic acid) and phosphorous acid in a solvent like acetonitrile, tetrahydrofuran, N-methyl-pyrrolidinone for the preparation of the corresponding bisphosphonic acid. The reaction was carried out at 65-75° C. and required six to eight hours time for completion. After that, the reaction mixture was cooled to 55-60° C. and water was added slowly to the stirred reaction mixture. The reaction mixture turned into a clear solution when heated to 90-100° C. for four to six hours to hydrolyze the phosphorous intermediate into the bisphosphonic acid. The bisphosphonic acid in the reaction mixture was then converted into its monosodium salt by adjusting the pH to 4.0-5.0 with sodium hydroxide solution. The resulting solution was then cooled to 0-5° C. for four to five hours to obtain the bisphosphonic acid monosodium salt, which was separated from the reaction mixture by filtration as a white solid with >97% HPLC purity.

For example, acetic acid gives etidronic acid, 3-amino-propionic acid gives pamidronic acid, 4-amino-butyric acid gives alendronic acid, 6-amino-hexanoic acid gives neridronic acid, 3-(dimethylamino)-propionic acid gives olpadronic acid, N-(n-pentyl)-N-methyl-3-amino-propionic acid gives ibandronic acid, 3-pyridyl-acetic acid gives risedronic acid, 1-imidazolyl-acetic acid gives zoledronic acid, and (3-imidazo[1,2-a]pyridine)-acetic acid gives minodronic acid.

The present invention will now be described by the following non-limiting illustrative examples.

### EXAMPLES

In the examples below, acetonitrile was used as solvent for the phosphorylation reaction. In a similar fashion other solvents like tetrahydrofuran, N-methyl-pyrrolidinone and acetone gave similar results (with respect to yield and quality of bisphosphonic acid monosodium salt).

### Example 1a

### Preparation of Risedronic Acid Monosodium Salt

A mixture of 3-pyridyl-acetic acid or its hydrochloride (20.0 g, 0.145 mol) and phosphorous acid (14.4 g, 0.175 mol) in acetonitrile (300 ml) was heated at a temperature of 55-65° C. and phosphorous trichloride (40.06 g, 0.290 mol) was added slowly under stirring. After completion of the addition, the reaction temperature was raised to 70-75° C. and the reaction continued for 6-9 hours at the same temperature. The reaction mixture was cooled to 60-65° C. and water (300 ml) was added slowly at the same temperature. The reaction temperature was then increased to 90-100° C. and maintained for the next 4-6 hours. The reaction mixture was then cooled to 55-65° C. and the reaction mixture pH was adjusted to 4.3-4.8 with sodium hydroxide solution. The reaction mixture was cooled to 25-35° C. and the aqueous layer containing the product was separated from the upper acetonitrile layer. The aqueous layer was cooled to and maintained at 0-5° C. for 3 hours. The solid product was separated by filtration and washed with water and finally with methanol to obtain sodium risedronate. The product was dried in a vacuum oven at 45-50° C. until loss on drying was less than 0.5% w/w. Yield: 25 g (56.20%). Appearance: white crystalline solid. Purity >97% (HPLC).

### Example 1b

### Preparation of the Hemipentahydrate Form of Risedronic Acid Monosodium Salt

The crude risedronic acid monosodium salt obtained in example 1a was further purified and crystallized as hemipentahydrate by the following process. Crude risedronic acid monosodium salt (20 g) was dissolved in water (10-16 volume) by heating at 60-70° C. and treated with activated carbon (2-5% w/w of crude sodium risedronate). The reaction mixture was filtered through a Celite® bed. Acetonitrile (or acetone or tetrahydrofuran) was added slowly to the clear filtrate at 60-65° C. to initiate nucleation. The solution was then slowly cooled to ambient temperature (25-28° C.) over a period of 2-3 hours. A solid crystallized out, which was filtered and rinsed with the same solvent as was used for the crystallization. The solid was finally dried in a vacuum oven at 50-55° C. to give sodium risedronate hemipentahydrate as white crystalline solid. Yield: 16 g (80%). Appearance: white crystalline solid. Purity: >99.7% (HPLC). The hemipentahydrate form was confirmed by comparing DSC, TGA, FTIR and XRPD analysis data of the product with data of a reference hemipentahydrate form of risedronic acid monosodium salt.

### Example 2

### Preparation of Pamidronic Acid Monosodium Salt

A mixture of 3-amino-propionic acid (10.0 g, 0.112 mol) and phosphorous acid (14.0 g, 0.168 mol) in acetonitrile (150 ml) was heated at a temperature of 55-65° C. and phosphorous trichloride (30.8 g, 0.224 mol) was added slowly under stirring. After completion of the addition, the reaction temperature was raised to 70-75° C. and the reaction continued for 6-9 hours at the same temperature. The reaction mixture was cooled to 60-65° C. and water (150 ml) was added slowly at the same temperature. The reaction temperature was then increased to 90-100° C. and maintained for the next 4-6 hours. The reaction mixture was then cooled to 55-65° C. and the reaction mixture pH was adjusted to 4.4-4.8 with sodium hydroxide solution. The reaction mixture was cooled to 25-35° C. and the aqueous layer containing the product was separated from the upper acetonitrile layer. Methanol (60 ml) was added to the aqueous layer and the mixture was cooled to and maintained at 0-5° C. for 3 hours. The solid product was separated by filtration and washed with water and finally with methanol to obtain sodium pamidronate. The product was dried in a vacuum oven at 50-55° C. until loss on drying was less than 0.5% w/w. Yield: 15 g (60.4%). Appearance: almost white crystalline solid. Melting range: 240-245° C. (with decomposition).

### Example 3

### Preparation of Alendronic Acid Monosodium Salt

A mixture of 4-amino-butyric acid (10.0 g, 0.097 mol) and phosphorous acid (15.9 g, 0.194 mol) in acetonitrile (150 ml) was heated at a temperature of 55-65° C. and phosphorous trichloride (26.6 g, 0.194 mol) was added slowly under stirring. After completion of the addition, the reaction temperature was raised to 70-75° C. and the reaction continued for 6-9 hours at the same temperature. The reaction mixture was cooled to 60-65° C. and water (150 ml) was added slowly at the same temperature. The reaction temperature was then increased to 90-100° C. and maintained for the next 4-6 hours. The reaction mixture was then cooled to 55-65° C. and the reaction mixture pH was adjusted to 4.4-4.8 with sodium hydroxide solution. The reaction mixture was cooled to 25-35° C. and the aqueous layer containing the product was separated from the upper acetonitrile layer. The aqueous layer was cooled to and maintained at 0-5° C. for 3 hours. The solid product was separated by filtration and washed with water and finally with methanol to obtain sodium alendronate. The product was dried in a vacuum oven at 45-50° C. until loss on drying was less than 0.5% w/w. Yield: 16 g (69.6%). Appearance: almost white powder. Melting range: 234-238° C. (with decomposition).

### Example 4

### Preparation of Neridronic Acid Monosodium Salt

A mixture of 6-amino-hexanoic acid (20.0 g, 0.152 mol) and phosphorous acid (18.8 g, 0.229 mol) in acetonitrile (300 ml) was heated at a temperature of 60-65° C. and phosphorous trichloride (41.8 g, 0.304 mol) was added slowly under stirring. After completion of the addition, the reaction temperature was raised to 70-75° C. and the reaction continued for 9 hours at the same temperature. The reaction mixture was cooled to 60-65° C. and water (150 ml) was added slowly at the same temperature. The reaction temperature was then increased to 95-100° C. and maintained for the next 5-6 hours. The reaction mixture was then cooled to 55-65° C. and the reaction mixture pH was adjusted to 4.4-4.8 with sodium hydroxide solution. The reaction mixture was cooled to 25-35° C. and the aqueous layer containing the product was separated from the upper acetonitrile layer. After addition of acetone (80 ml), the aqueous layer was cooled to and maintained at 0-5° C. for 3 hours. The solid product was separated by filtration and washed with water and finally with methanol to obtain sodium neridronate. The product was dried in a vacuum oven at 45-50° C. until loss on drying was less than 0.5% w/w. Yield: 18 g (44.4%). Appearance: off-white powder. Melting range: 232-239° C. (with decomposition).

1. A process of preparing a bisphosphonic acid or a salt thereof, comprising the step of phosphorylating a carboxylic acid or a salt thereof with phosphorous acid and a phosphorous halide in the presence of a polar organic solvent, provided that the polar organic solvent is not methane sulfonic acid, sulfolane, 1,2-dimethoxyethane, dioxane or diglyme.

2. The process as claimed in claim 1, wherein:
(a) the carboxylic acid or the salt thereof is RCH₂—CO₂H or a salt thereof, wherein R is an alkyl, aralkyl, aromatic or heteroaromatic group which can be optionally substituted with —NR₁R₂ where R₁, and R₂, are independently hydrogen or an alkyl group; and/or
(b) the carboxylic acid is selected from acetic acid, 3-amino-propionic acid, 4-amino-butyric acid, 6-amino-hexanoic acid, 3-(dimethylamino)-propionic acid, N-(n-pentyl)-N-methyl-3-amino-propionic acid, 3-pyridyl-acetic acid, 1-imidazolyl-acetic acid, or (3-imidazo[1,2-a]pyridine)-acetic acid; and/or
(c) the phosphorous halide is selected from phosphorous trichloride, phosphorous pentachloride or phosphorous oxychloride.

3. The process as claimed in claim 1, wherein the process further comprises the step of preparing a salt of the bisphosphonic acid.

4. The process as claimed in claim 3, wherein the salt is:
(a) a sodium, potassium, calcium or magnesium salt; or
(b) a sodium salt; or
(c) a mono- or disodium salt; or
(d) a monosodium salt.

5. The process as claimed in claim 3, wherein the bisphosphonic acid salt is prepared in the presence of water and a polar organic solvent.

6. The process as claimed in claim 3, wherein the process further comprises the step of recrystallising the bisphosphonic acid salt using water and a polar organic solvent.

7. The process as claimed in claim 1, wherein the polar organic solvent is selected from:
(a) an organonitrile, a ketone, a cyclic ether, or a mixture thereof; or
(b) acetonitrile, benzonitrile, propionitrile, acetone, tetrahydrofuran, N-methyl-pyrrolidinone, dimethylformamide, dimethylacetamide, dimethyl sulfoxide, or a mixture thereof; or
(c) acetonitrile, benzonitrile, propionitrile, acetone, tetrahydrofuran, N-methyl-pyrrolidinone, or a mixture thereof.

8. The process as claimed in claim 5, wherein the polar organic solvent is selected from:
(a) an organonitrile, a ketone, a cyclic ether, or a mixture thereof; or
(b) acetonitrile, benzonitrile, propionitrile, acetone, tetrahydrofuran, N-methyl-pyrrolidinone, dimethylformamide, dimethylacetamide, dimethyl sulfoxide, or a mixture thereof; or
(c) acetonitrile, benzonitrile, propionitrile, acetone, tetrahydrofuran, N-methyl-pyrrolidinone, or a mixture thereof.

9. The process as claimed in claim 6, wherein the polar organic solvent is selected from:
(a) an organonitrile, a ketone, a cyclic ether, or a mixture thereof; or
(b) acetonitrile, benzonitrile, propionitrile, acetone, tetrahydrofuran, N-methyl-pyrrolidinone, dimethylformamide, dimethylacetamide, dimethyl sulfoxide, or a mixture thereof; or
(c) acetonitrile, benzonitrile, propionitrile, acetone, tetrahydrofuran, N-methyl-pyrrolidinone, or a mixture thereof.

10. The process as claimed in claim 1, wherein the process further comprises:
(a) the step of preparing a salt of the bisphosphonic acid, and wherein the solvent used for the phosphorylation step and the solvent used for the salt preparation step are the same; and/or
(b) the step of preparing a salt of the bisphosphonic acid and the step of recrystallising the bisphosphonic acid salt using water and a polar organic solvent, and wherein the solvent used for the phosphorylation step and the solvent used for the recrystallisation step are the same; and/or
(c) the step of preparing a salt of the bisphosphonic acid and the step of recrystallising the bisphosphonic acid salt using water and a polar organic solvent, and wherein the solvent used for the salt preparation step and the solvent used for the recrystallisation step are the same; and/or
(d) the step of preparing a salt of the bisphosphonic acid and the step of recrystallising the bisphosphonic acid salt using water and a polar organic solvent, and wherein the solvent used for the phosphorylation step, the solvent used for the salt preparation step and the solvent used for the recrystallisation step are the same.

11. The process as claimed in claim 1, wherein:
(a) the process is a single-pot reaction process; and/or
(b) the bisphosphonic acid or the salt thereof is obtained on an industrial scale; and/or
(c) the bisphosphonic acid or the salt thereof is obtained in a yield of more than 40%; and/or
(d) the bisphosphonic acid or the salt thereof is obtained with an HPLC purity of more than 97%.

12. A bisphosphonic acid or a salt thereof when prepared by a process as claimed in claim 1.

13. A process of preparing a bisphosphonic acid salt, comprising the step of converting a bisphosphonic acid into a salt thereof in the presence of water and a polar organic solvent, provided that the polar organic solvent is not methane sulfonic acid, sulfolane, 1,2-dimethoxyethane, dioxane or diglyme.

14. A bisphosphonic acid salt when prepared by a process as claimed in claim 13.

15. A process of recrystallising a bisphosphonic acid salt using water and a polar organic solvent.

16. A bisphosphonic acid salt when prepared by a process as claimed in claim 15.

17. A process of preparing sodium risedronate hemipentahydrate, comprising the steps of:
(a) phosphorylating 3-pyridyl-acetic acid with phosphorous acid and a phosphorous halide in the presence of a polar organic solvent selected from acetonitrile, benzonitrile, propionitrile, acetone, tetrahydrofuran, N-methyl-pyrrolidinone, dimethylformamide, dimethylacetamide, dimethyl sulfoxide, or a mixture thereof, to obtain a phosphorous intermediate;
(b) hydrolysing the phosphorous intermediate with sodium hydroxide to obtain sodium risedronate; and
(c) recrystallising the sodium risedronate using water and the same polar organic solvent used in step (a) to obtain sodium risedronate hemipentahydrate.

18. The process as claimed in claim 17, wherein:
(a) the phosphorous halide is selected from phosphorous trichloride, phosphorous pentachloride or phosphorous oxychloride; and/or
(b) the solvent is selected from acetonitrile, benzonitrile, propionitrile, acetone, tetrahydrofuran, N-methyl-pyrrolidinone, or a mixture thereof; and/or
(c) the solvent is selected from acetonitrile, acetone, tetrahydrofuran or N-methyl-pyrrolidinone; and/or
(d) the process is a single-pot reaction process; and/or
(e) the sodium risedronate hemipentahydrate is obtained on an industrial scale; and/or
(f) the sodium risedronate hemipentahydrate is obtained in a yield of more than 40%; and/or
(g) the sodium risedronate hemipentahydrate is obtained with an HPLC purity of more than 98%; and/or
(h) the sodium risedronate hemipentahydrate is obtained substantially free from other hydrates.

19. Sodium risedronate hemipentahydrate when prepared by a process as claimed in claim 17.

20. A process of recrystallising risedronate sodium in hemipentahydrate form using water and a polar organic solvent.

21. The process as claimed in claim 20, wherein:
(a) the solvent is selected from an organonitrile, a ketone, a cyclic ether, or a mixture thereof; and/or
(b) the solvent is selected from acetonitrile, benzonitrile, propionitrile, acetone, tetrahydrofuran, N-methyl-pyrrolidinone, dimethylformamide, dimethylacetamide, dimethyl sulfoxide, or a mixture thereof; and/or
(c) the solvent is selected from acetonitrile, benzonitrile, propionitrile, acetone, tetrahydrofuran, N-methyl-pyrrolidinone, or a mixture thereof; and/or
(d) the sodium risedronate hemipentahydrate is obtained on an industrial scale; and/or
(e) the sodium risedronate hemipentahydrate is obtained in a yield of more than 40%; and/or
(f) the sodium risedronate hemipentahydrate is obtained with an HPLC purity of more than 98%; and/or
(g) the sodium risedronate hemipentahydrate is obtained substantially free from other hydrates.

22. Sodium risedronate hemipentahydrate when prepared by a process as claimed in claim 20.

23. Sodium risedronate hemipentahydrate with an HPLC purity of more than 99.5%.

24. An industrial process of preparing sodium risedronate hemipentahydrate, wherein the sodium risedronate hemipentahydrate has an HPLC purity of more than 99.5% and is substantially free from other hydrates.

25. An industrial process of preparing sodium risedronate hemipentahydrate from sodium risedronate in one or more other hydrate or anhydrate forms, wherein the sodium risedronate hemipentahydrate has an HPLC purity of more than 99.5% and is substantially free from other hydrates.

26. An industrial process of preparing sodium risedronate, comprising the step of phosphorylating 3-pyridyl-acetic acid in the presence of a polar, water miscible, organic solvent.

27. The process as claimed in claim 26, wherein:
(a) the solvent prevents the hardening of the reaction mass during the phosphorylation reaction; and/or
(b) the solvent is selected from an organonitrile, a ketone, a cyclic ether, or a mixture thereof; and/or
(c) the solvent is selected from acetonitrile, benzonitrile, propionitrile, acetone, tetrahydrofuran, N-methyl-pyrrolidinone, dimethylformamide, dimethylacetamide, dimethyl sulfoxide, or a mixture thereof; and/or
(d) the solvent is selected from acetonitrile, benzonitrile, propionitrile, acetone, tetrahydrofuran, N-methyl-pyrrolidinone, or a mixture thereof.
